(19) United States
(12) Patent Application Publication
(10) Pub. No.: US 2015/0230666 A1
(43) Pub. Date: Aug. 20, 2015

(54) Improvements to a food cutting board

(71) Applicant: Winston MacKelvie, Knowlton (CA)

(72) Inventor: Winston MacKelvie, Knowlton (CA)

(21) Appl. No.: 14/544,794

(22) Filed: Feb. 18, 2015

(30) Foreign Application Priority Data
Feb. 18, 2014 (CA) 2843015

(51) Int. Cl. A47J 47/00

(52) U.S. Cl. CPC A47J 47/005

(57) ABSTRACT

A food preparation cutting board offers improved hygiene by having a recess formed in the board to receive a reversible-removable insert. A notch through the board intersects a marginal portion of the recess wall. The insert therefore has an overhanging ledge over which off-cuts from food prepared on the insert are swiped over the ledge where they air drop into a container below without contacting and contaminating the board.

### FIELD OF THE INVENTION

The field is cutting boards used for food preparation in kitchens.

### BACKGROUND OF THE INVENTION

Food preparation creates a wide range of solid, mushy and liquid detritus that can accumulates and overflow a cutting board's edges. Boards are often heavy but nevertheless must be regularly carried to a sink for cleaning to maintain. The instant invention provides a insert on which the food preparation takes place.

### SUMMARY OF THE INVENTION

A larger and heavier main board is provided with a recess extending inwardly from one edge, and a notch extending inwardly from one end and intersecting the recess. A removable insert fits snuggly in the recess and therefore overhangs the notch. Stubs extending from the insert's edges prevent its movement during use.

In use, food off-cuts (solid. mush, and liquid waste) can be swiped off the overhanging edge of the insert thereby allowing the waste to air drop through the notch without contacting the main board. Because the main board never gets cut or contaminated, it can have a sanitary waterproof coating and can remain permanently in place.

The lightweight insert is easily removed for regular cleaning. while the heavier and harder to clean main cutting board stays clean at all times. This, in turn, prevents bacterial and insect contamination.

The board may be positioned over a receptacle, such as a kitchen sink or a purpose-built container, to receive the food off-cuts falling through the notch.

Another hygienic benefit of the instant design is that the main board can be finished with a food-safe, waterproof coating that can be quickly and easily wiped clean and dry without having to move the board to the kitchen sink to wash and drip dry. Such repeated cleaning of traditional boards is not only tedious but removes the protective oil so re-oiling becomes required maintenance.

To prevent accidental sliding of the insert in its recess while cutting on it, a preferred embodiment uses pins inserted into the insert's edges leaving stub ends exposed. The stub in one edge contacts the notch wall thereby preventing slippage of the insert. The stub in the opposite edge engages a small recess or pocket provided at a complementary location on the opposite wall of the recess.

A second embodiment a magnet is recessed in the board and steel rods inserted into the insert so as to be above the magnet. The attraction force between the steel and magnet creates friction therebetween to retain the insert yet still allow its easy removal.

A third embodiment uses springy tangs carved up from the inserts edges. As before, these tangs engage the notch wall and pocket. A combination of embodiments can be used.

Several low-cost inserts in different colours and materials (wood, plastic, marble, glass) can be kept on hand for rapid change and for use with food groups such as aromatics (i.e., garlic. fish), vegetables, and sandwich making, and to satisfy religious and cultural laws and norms. Inserts can be used as servers for the food adding additional benefit.

### BRIEF DESCRIPTION OF THE DRAWINGS

FIG. 1 is a top view without the insert showing the shallow recess formed in the board's surface and intersected by the notch or aperture;

FIG. 2 shows a perspective of the insert and also shows three retention means for the insert: steel rods, stubs, and tangs;

FIG. 3 shows a cross section view of line 3-3 in FIG. 1 showing how the food off-cuts air drop off the overhanging ledge of the insert into a container means below (in dotted outline). Also shown are the rod and magnet, and, the stub, tang, and related pocket;

FIG. 4 shows an end view of the instant cutting board with the insert suspended above the recess showing the stub;

FIG. 5 is a front view of the food preparation board resting on a purpose-built base which has provision for a slide-out off-cuts collection drawer;

FIG. 6 shows a close-up of the circled region in FIG. 5 detailing the recesses intersected (missing) wall which results in a marginal edge of the insert becoming an unsupported ledge that overhangs the notch opening;

FIG. 7 show a portion of FIG. 1 with the recess with no notch arms such that the insert's overhanging ledge is at the very end of the main cutting board.

### DETAILED DESCRIPTION OF THE INVENTION

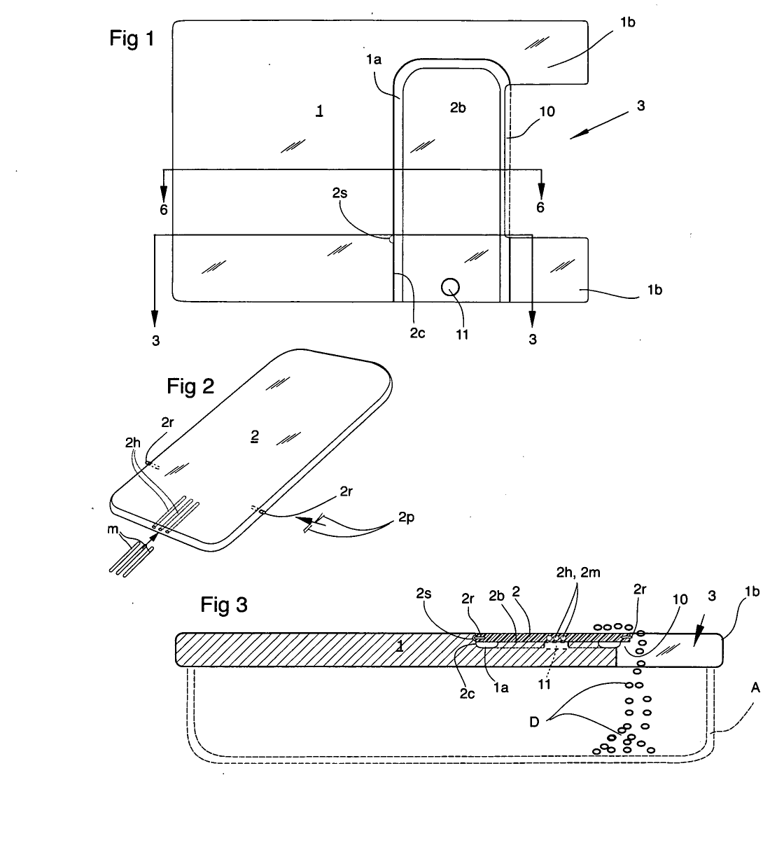

In FIG. 1 flat planar cutting board 1 has a shallow recess 2b to removably receive insert 2 (FIG. 3) which preferably is slightly thinner than the depth of recess 2b so as to allow food to be swept/swiped across it without impediment. Recess 2b has a radiused perimeter groove 1a to collect detritus that would otherwise cause the insert 2 to be unstable by resting on crumbs and the like that might get beneath it from time to time.

Also in FIG. 1 is shown the notch or aperture 3 formed in the end portion of the board 1 with side arms 1a to support the board as will be described later. Notch 3 intersects recess 2b and groove 1a (dotted line) thereby removing a central portion of them so as to leave a gap 10 between arms 1a. This gap 10 allows a central portion of the insert 2 to be ledge-like and overhang notch 3.

To prevent the insert sliding fore and aft in the recess, FIG. 2 shows retentive embodiments. In one embodiment the front edge of the insert has holes 2h into which steel rods 2m are permanently inserted and which are attracted to a magnet 11 recessed in the board below thereby providing a frictional grip between.

In a preferred embodiment, FIG. 2 shows how pins inserted into the both side edges of insert 2 have exposed ends or stubs 2r, one to engage the wall of the notch 1b and the other to engage a small pocket 2s in wall 2c across from the notch. Of course the stubs and pocket can be located anywhere along the notch region. In another embodiment, instead of stubs, tangs 2p may be raised from the insert edge to engage the notch 3 and recess 2s.

In FIGS. 3, 5, and 6 is shown how food off-cuts D including liquids, can air drop from the insert 2 and through gap 10 and notch 3 without contacting board 1. A container or receptacle A or B below may be provided to receive the off-cuts.

The arrangement improves hygiene by preventing contamination the main board with blood, juice, mush as well as crumbs, skins and the like. Such a rich nutrient buildup would inevitably leads to unwanted bacteria growth, insect attraction and generally non-hygienic conditions. This is made more likely when the main cutting board is large, heavy and unwieldy making cleaning and drying it inconvenient and therefore infrequent. The instant invention overcomes this potential danger by providing a lightweight insert 2 that is easily removed for cleaning.

FIGS. 3 and 4 show an off-cuts base/receptacle A, that may even be a kitchen sink, over which the board 1 is supported by arms 1a.

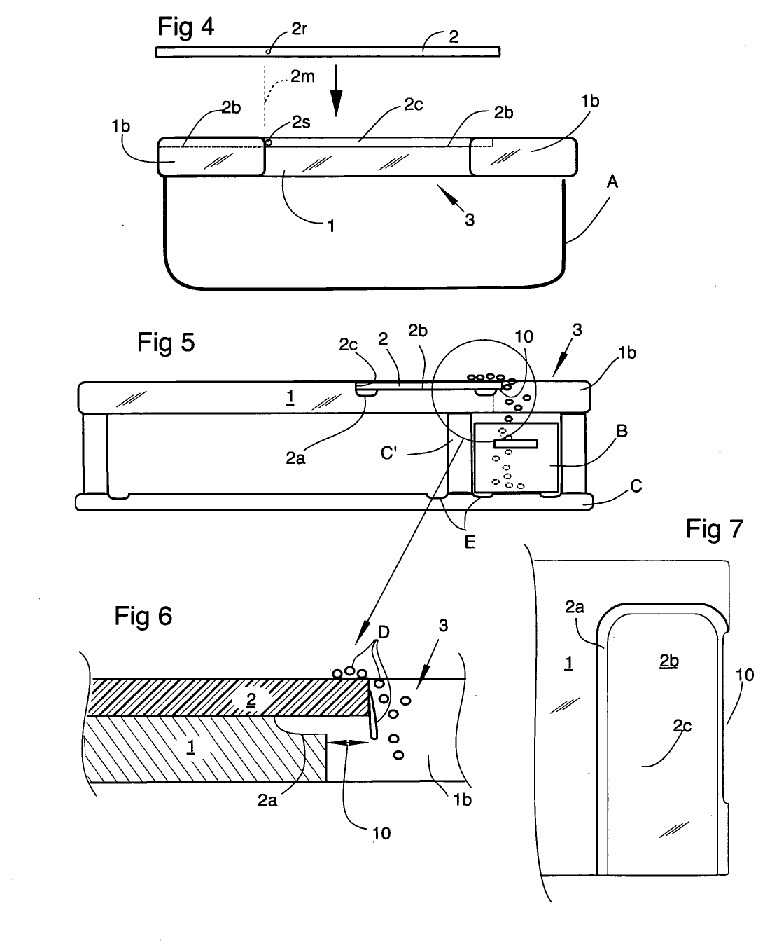

In FIG. 5 shows the preferred embodiment that includes a separate base C with supports C′ for board 1, all arranged to provide a space for an off-cuts drawer B that slides out for emptying.

FIG. 6 shows a close-up or enlarged view of the circled portion in FIG. 5, showing in detail how of the edge of the inset 2 becomes a ledge 10 overhanging notch 3, and how the falling off-cuts are thereby air drop without contacting board 1.

FIG. 7 shows an embodiment where the insert 2 extends to the right end of the board 1 maintaining the hygienic benefits of the gap 10. This embodiment is advantageous when the cutting board is to be used at the end of a table or counter because it allows off-cuts to air drop to a receptacle placed on the floor or on a shelf below.

I claim:

1. A food preparation board comprising:
a board having a front edge and first end;
a recess in the board, the recess extending inwardly from the front edge;
an insert to fit the recess;
an aperture in the board extending inwardly from the first end so as to intersect a marginal portion of the recess;
the arrangement being that a portion of the insert overhangs the aperture.

2. The food preparation board of claim 1 wherein said insert includes magnetic material therein, a magnet in said board arranged to magnetically retain said insert in a desired position.

3. The food preparation board of claim 1 wherein said insert includes an outwardly extending member, said outwardly extending member arranged to engage a portion of said board to retain said insert in a desired position.

4. The food preparation board of claim 3 wherein said outwardly extending member comprises a stub.

5. A food preparation board comprising:
a board;
an aperture formed in said board;
a recess formed in an upper surface of said board, said recess extending inwardly from at least a portion of a marginal edge of said board, said recess also extending along an edge of said aperture;
an insert designed to fit within said recess; and
a second recess formed in said board, said second recess being located where said recess extends along said edge of said aperture.

6. The food preparation board of claim 5 wherein said insert includes magnetic material therein, a magnet in said board arranged to magnetically retain said insert in a desired position.

7. The food preparation board of claim 5 wherein said insert includes an outwardly extending member, said outwardly extending member arranged to engage a portion of said board to retain said insert in a desired position.

8. The food preparation board of claim 7 wherein said outwardly extending member comprises a stub.
